(19) United States
(12) Patent Application Publication
(10) Pub. No.: US 2018/0058029 A1
(43) Pub. Date: Mar. 1, 2018

(54) DEVICE FOR CUTTING CONCRETE PILES

(71) Applicant: MOTOCUT OY, Kerava (FI)

(72) Inventor: Teppei MORIMOTO, Metsakansa (FI)

(73) Assignee: MOTOCUT OY, Kerava (FI)

(21) Appl. No.: 15/558,291

(22) PCT Filed: Mar. 22, 2016
(86) PCT No.: PCT/FI2016/050176

§ 371 Date: Sep. 14, 2017

(30) Foreign Application Priority Data
Mar. 24, 2015 (FI) 20155206

(51) Int. Cl. E02D 9/00; B28D 1/04; B28D 7/00; B28D 7/04; B23D 45/00; B23D 59/00

(52) U.S. Cl. CPC E02D 9/005; B28D 1/044; B28D 7/005; B23D 59/008; B23D 45/006; B23D 59/001; B28D 7/04

(57) ABSTRACT

The invention relates to a device for cutting concrete piles. The device having a frame, gripping means connected to the frame and including at least two opposing gripping parts, which are movable at least closer to each other to form a closing grip around a pile and further away from each other to release the pile from the closing grip, and sawing means, which are arranged to perform a back and forth sawing movement on the two opposite sides of the pile moving along a horizontal guide rail attached to the frame and which is further arranged to turn towards the pile to be sawed and back around their rotational axis. The invention further relates to computer program means suitable for controlling a device according to the invention to perform a desired sawing profile in the concrete pile.

The invention relates to a device for cutting concrete piles.

### BACKGROUND OF THE INVENTION

Steel and reinforced concrete piles are generally used to form the foundations of buildings. The piles are installed in the soil preferably so deep that the friction between the pile and the soil guarantees the attachment of the pile or that they strike harder soil, such as bedrock. The piles function as a load-bearing structure, which takes on compressive and bending stresses.

Piles that have been installed into the soil generally need to be cut at a suitable height in order to continue with the following construction stages. When the installation of the piles into the soil has proceeded without difficulties and the piles receive support from the soil, the reinforced concrete piles can be shortened by sawing the concrete and steel reinforcements and, if necessary, by cutting until a nearly level cutting surface has been achieved.

When it is desired to have a stiff joint between the pile and the concrete footing cast onto it, an approximately 10-80 cm length of the steel rebars of the pile are further left exposed. Stiffening the joint in this manner is necessary, when reinforced concrete piles settle in the soil into a slanting position, for example, due to characteristics of the soil. Also, when the embedded length of the pile, i.e. the length of the pile that remains below the surface of the ground, remains below 3 metres or, in the case of tall structures, it is necessary to leave the steel rebars of the concrete pile exposed for a given length.

The cutting of a concrete pile according to prior known art such that the steel rebars are left exposed for a certain length is presented in the following. In so-called demolition cutting, the piles are first cut at a higher cutting level, which is equal to the desired load-bearing cutting level of the pile added to the desired bonding length of the steel rebars. The pile is sawed at this level generally by sawing manually or with a cutting device coupled to a machine. After the higher cutting, at the desired load-bearing cutting level, a groove is cut in the concrete such that the steel rebars are not damaged. After the sawing, the steel rebars are exposed down to the desired load-bearing cutting level. This exposing of the steel rebars occurs according to prior known art such that the concrete between the steel rebars is crushed by a machine and/or manually, for example, by a sledge hammer and the cutting surfaces are finished by cutting manually.

Removing the concrete between the steel rebars in this manner is slow and laborious. A disadvantage is also that, in crushing, the concrete cracks and comes off in an uncontrolled manner. The concrete can come off or split by accident also below the desired cutting level. In this case, it can occur that the amount of intact pile that extends to the concrete footing is less than the minimum 50 mm in length, which significantly weakens the joint and thus the foundation. Another disadvantage is that, through the cracks in the concrete pile, moisture can gain access to the steel and damage it by corrosion. This danger is particularly great if the cracks extend below the surface of the ground.

From publication WO 2013/153286 is known a cutting device to be connected to a machine for cutting concrete piles. The cutting device disclosed in the publication comprises gripping means, which are capable of gripping around the pile to be cut, and at least two sawing means, which are arranged horizontally movable in the longitudinal direction of the gripping means along a guide rail as well as movable towards the pile to be cut and away from it.

By using a device like said cutting device, it is quite possible to automate the cutting of reinforced concrete piles. When using the device for demolition cutting of steel rebar, several disadvantages have become evident. The mechanism of the device for moving the saw towards the pile to be sawed contains a flexible feature, the purpose of which is to protect the blade from strong compressive stresses, when it hits harder sites in the concrete. However, flexibility dimensioned as too soft can cause bouncing of the blade and thus negatively affect the durability of the blade and the cutting result. By using a device of the current type, it is also not possible to implement automated cutting to expose the steel rebars. In cutting to expose the steel rebars, it is essential to stop the sawing motion of the sawing means at a suitable point before the saw blade strikes the steel rebars, while one should saw as deeply as possible to cut the pile, which has been difficult by using a device of prior known art. The later stage of sawing, in which the concrete is removed from around the steel rebars to leave them exposed, has also been necessary to perform manually by using a different device.

### Object of the Invention

The object of the invention is to eliminate above said disadvantages of the solutions of prior known art. In particular, the object is to provide a method for the demolition cutting of the steel rebars of the concrete piles, which occurs by using a cutting device connected to a machine and a device for this same purpose.

### SUMMARY OF THE INVENTION

The presented disadvantages are resolved by using a device according to independent claim 1.

A device according to the invention for the demolition cutting of concrete piles comprises a frame, gripping means connected to the frame and comprising at least two opposing gripping parts, which are movable at least closer to each other to form a closing grip around a pile and further away from each other to release a pile from the closing grip, and sawing means, which are to be arranged on the two opposite sides of the pile to perform a back and forth sawing movement moving along a horizontal guide rail attached to the frame and which are further arranged to turn towards the pile to be sawed and back around their rotational axis. A device according to the invention has, attached to the end of the rotational axis of the turning mechanism, an angle sensor for measuring the angle of rotation of the sawing means.

According to one embodiment of the invention, the device comprises an adjustable friction brake arranged in the turning mechanism. The friction brake is intended to brake the turning movement of the sawing means and the flexibility during the sawing caused by the flexible element, for example, a torsion spring, of the turning mechanism. The braking power of the friction brake can be adjusted, for example, with adjustment screws provided with a spring, for example, according to the quality of the concrete to be cut.

According to another embodiment of the invention, the device comprises an inductive sensor to detect the steel rebars in the pile.

The invention also relates to computer program means, which contain the control commands of the device for performing various sawing profiles in the concrete pile.

By using a device according to the invention, the demolition cutting of the steel rebars of the concrete piles comprises the stages presented in the following:

The gripping means grip onto the pile such that the sawing means are located at a height, which corresponds to the desired cutting level of the pile added to the desired height of the steel rebars to be left exposed.

The pile is cut at this height by the sawing means, at least until all the steel rebars have been sawed through. In this stage, the pile is sawed either completely through, or it is sawed deep enough that it can be cut by the movement of a boom and a cutting device connected to the boom. Next, the part of the pile to be removed is removed from the pile.

The gripping means grip onto the pile at such a height that the sawing means settle essentially horizontally at the desired cutting height of the concrete demolition cutting.

In the second sawing, the sawing means are moved in an essentially horizontal back and forth sawing movement along both edges of the pile to be cut, while the pressure element presses the sawing means into the pile to be cut. According to one embodiment, this pressure element is a torsion spring coupled to the turning mechanism of the sawing means, which turns the sawing means towards the pile.

The progress into the concrete of the sawing movement of the sawing means is controlled on the basis of a signal from at least one sensor such that the sawing progresses as deeply as possible into the concrete without the sawing means striking the steel rebars in the concrete, wherein the sawing means progress deeper into the concrete between steel rebars than at the steel rebars.

Said sensor signal can be a value given by the angle sensor of the turning mechanism of the sawing means, i.e. the automation stops or moves the sawing means when it has turned by an amount of a pre-set angle value. Preferably, the device is provided with at least one inductive sensor, which is arranged to detect the steel reinforcements within the concrete, which the sawing means approach.

Finally, the concrete that has remained between and around the steel rebars to be left exposed is removed from above the desired cutting level in order to achieve the desired cleaned cutting level for the steel rebars to remain exposed.

The cutting method can further comprise a stage, in which the sawing means are turned 90° around the pile to be cut.

The pile is cut by the sawing means preferably from both sides simultaneously.

The cutting method can further comprise a stage, in which the automation of the machine defines on the basis of a signal sent by a sensor the actual sawing depth of the sawing means in the pile and, on this basis, controls the movement of the sawing means in the direction of the edge of the pile or stops the movement of the blade of the sawing means.

Although the stages are presented in this order, the stages of cutting can also be implemented in a different order. If, by means of a cutting method to be performed by a device according to the invention, it has not been able to remove enough concrete to achieve a clean demolition cutting level and leave the bare steel rebars exposed, additional sawing can also be performed, for example, horizontally between the steel rebars from one side of the pile to its other side. Alternatively, additional sawing can also be performed in the vertical direction of the pile between the steel rebars to be left exposed between the upper surface of the pile and the desired cutting level of the concrete. This additional sawing can occur, for example, automatically by an auxiliary saw connected to the cutting device.

By using a device according to the invention, the demolition cutting of concrete piles can be mostly automated, which saves considerably on workforce and time spent on the worksite. By using an angle sensor, the sawing means of the cutting device can be driven to the desired depth in the concrete without cutting the steel rebars.

When a friction brake is coupled to the turning mechanism of the sawing means, the bouncing of the saw as it hits harder sites in the concrete is decreased. Due to this, the saw progresses better in sawing the concrete and, at the same time, the wearing of the blade is also decreased.

The presented other sawing stages and use of an auxiliary saw promote removal of the concrete from the pile, wherein the manual crushing stage after the sawing can be omitted. Use of an auxiliary saw further speeds up the cutting process, because when using an auxiliary saw, there is no need to remove the gripping grapple between work stages and turn the device.

### LIST OF FIGURES

FIG. 1 shows schematically the cutting profile of a concrete pile cut according to a cutting method according to one embodiment and performed by a device according to the invention;

FIG. 2 shows schematically the cutting profile of a concrete pile cut according to a cutting method according to another embodiment and performed by a device according to the invention;

FIG. 3 shows a perspective view of one embodiment of a device according to the invention;

FIGS. 4a-4c show one embodiment of the turning mechanism of a device according to the invention.

### DETAILED DESCRIPTION OF THE FIGS.

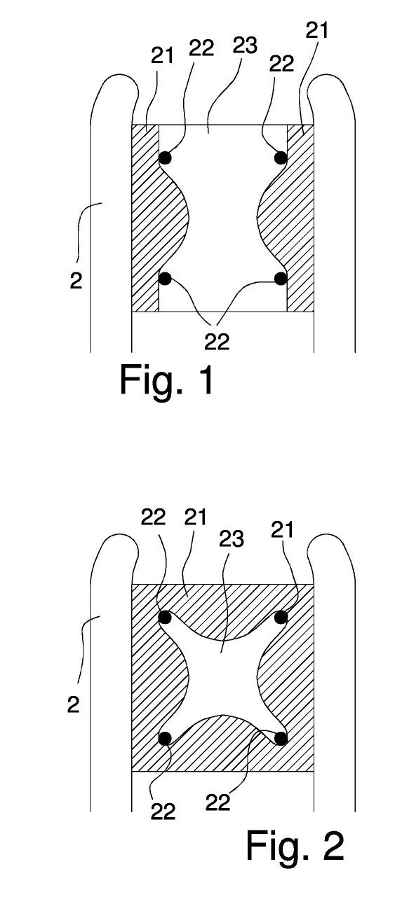

FIGS. 1-2 show the cutting stages of the concrete of a concrete pile used in a cutting method performed by a device according to the invention.

By using a device according to the invention, it is best possible to perform demolition cutting of the steel rebars in the rectangular concrete piles, as shown in FIGS. 1-3. The steel rebars 22 extending longitudinally in the rectangular piles 23 are generally arranged in the corners, wherein in each corner of a concrete pile 23 is located one steel rebar 22. Depending on the thickness of the concrete pile 23, which is typically 20-45 cm, to the middle between the steel rebars remains thus approximately 10-35 cm free space, which can be sawed.

Concrete is often cut by a diamond wheel or diamond chain saw. The aim is always to saw the concrete as deeply as possible to cut the pile, however, without damaging the steel rebars.

FIG. 1 shows schematically a concrete pile 23, which the gripping means 2 hold in a closing grip. The gripping means 2 hold onto the pile 23 during the sawing and prevent its uncontrolled falling. In a cutting method performed by a device according to the invention, the pile 23 is sawed from both sides of the pile as deeply as possible without striking the steel rebars 22. FIG. 1 shows the cutting surface 21 achieved by sawing. In this example, the pile 23 is sawed in a back and forth sawing movement along the edge of the pile and between the steel rebars 22, in which the diamond cutting edge of the sawing means 3 is able to progress a little deeper. Preferably, the device used has two sawing means arranged opposite each other, wherein it is possible to saw the pile from both sides simultaneously. If necessary, the device can also be programmed to saw one side at a time. The device can also have more than two sawing means.

FIG. 2 shows the cutting surface 21 achieved in the pile 23 when, after the sawing shown in FIG. 1, the sawing means are turned 90° around the pile, after which is performed the same kind of cutting as in FIG. 1. The sawing means 3 can be arranged 90° turnable around the pile, the frame of the cutting device being in its place, wherein the gripping means 2 do not need to release their grip during the turning. However, it is often necessary to temporarily release at least one gripping means 2, after which the cutting device can be turned and thereafter again take hold of the pile with the gripping means 2.

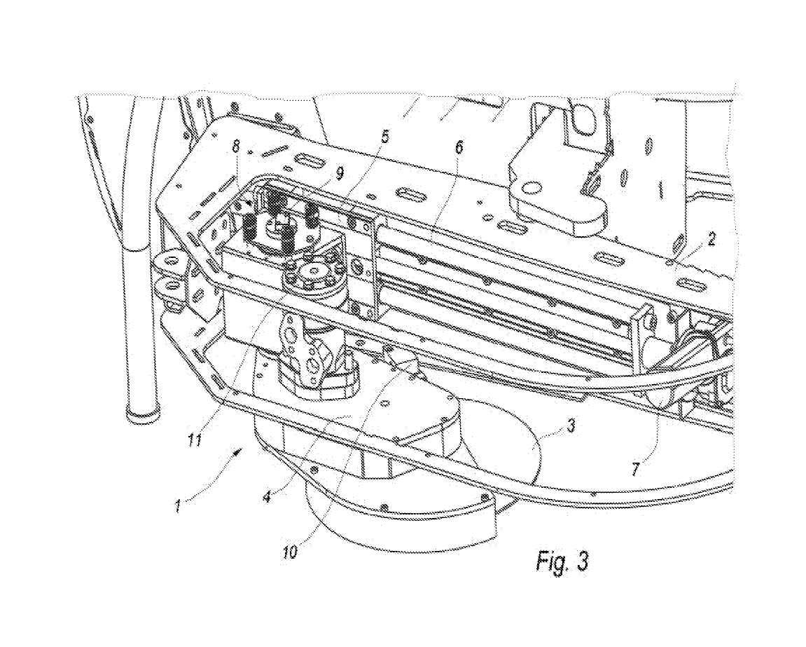

FIG. 3 shows a perspective view of one embodiment of a cutting device according to the invention. The figure shows the opposite side of the device, which has movable gripping means 2 and sawing means 3. Preferably, the opposite side of the device 1 is arranged identically as a mirror image. The sawing means 3 and its moving mechanisms are herein attached to the gripping means 2. The sawing means 3 can be attached pivotable and/or movable also to the frame of the cutting device. The sawing means 3 of the figure are arranged to move in the longitudinal direction of the gripping means 2 and thus along the guide rail 6 along the edges of the concrete pile. The saw carriage 5 can be moved along the guide rail 6, for example, by means of a trapezoidal screw, which is moved by the drive motor 7. According to one embodiment, the drive motor 7 can be a servo motor, wherein it is possible to precisely control the location of the sawing means in the longitudinal direction of the gripping means 2. In connection with the trapezoidal screw can also be arranged a separate detector (not shown), which precisely indicates the location of the saw carriage. The sawing means 3 are arranged to be turned towards the pile to be sawed and away from it by a turning mechanism 8, and the rotating sawing movement of the sawing means is created by a drive motor 11. In both ends of the rotational axis of the turning mechanism 8 of the sawing means is fitted an angle sensor 9, which gives a signal regarding the angle of rotation of the saw blade. The automation system can by means of the angle of rotation, the location of the saw carriage 5 and the structural dimensions precisely calculate the location of the cutting edge of the sawing means 3 in the concrete pile 23, wherein it can guide the sawing means 3 along a desired sawing path in the pile. The cutting device 1 is further provided with at least one inductive sensor 10 to detect the steel rebars in the concrete, wherein it is possible to stop the movement of the sawing means 3 of the device 1, when the sensor 10 comes too close to a steel rebar.

Preferably, the majority of the demolition cutting of the steel rebars of the concrete pile is automated, for example, using logic control. According to one embodiment, the machine operator performs cutting of the pile at a height, which corresponds to the desired embedded length of the pile 23 added to the desired height of the steel rebars 22 to be left exposed, and after this moves the cutting device 1 to the desired cutting height of the concrete. It may be necessary for the user to feed the dimensions of the concrete pile 23 into the control system, or the cutting device 1 may have sensors for defining the distance between the gripping means 2 and thus the thickness of the pile 23. Preferably, after this, the user can start the automatic program for demolition cutting of steel rebars, which performs the horizontal sawing according to the method and, if necessary, additional sawings for removal of the concrete. If necessary, the user controls in each of the stages the gripping onto the piles 23 by the gripping means 2, the releasing off by the gripping means 2 and the movement and/or turning of the cutting device 1 to a desired site. The user can also control the lifting away from the pile 23 of the concrete pieces to be removed.

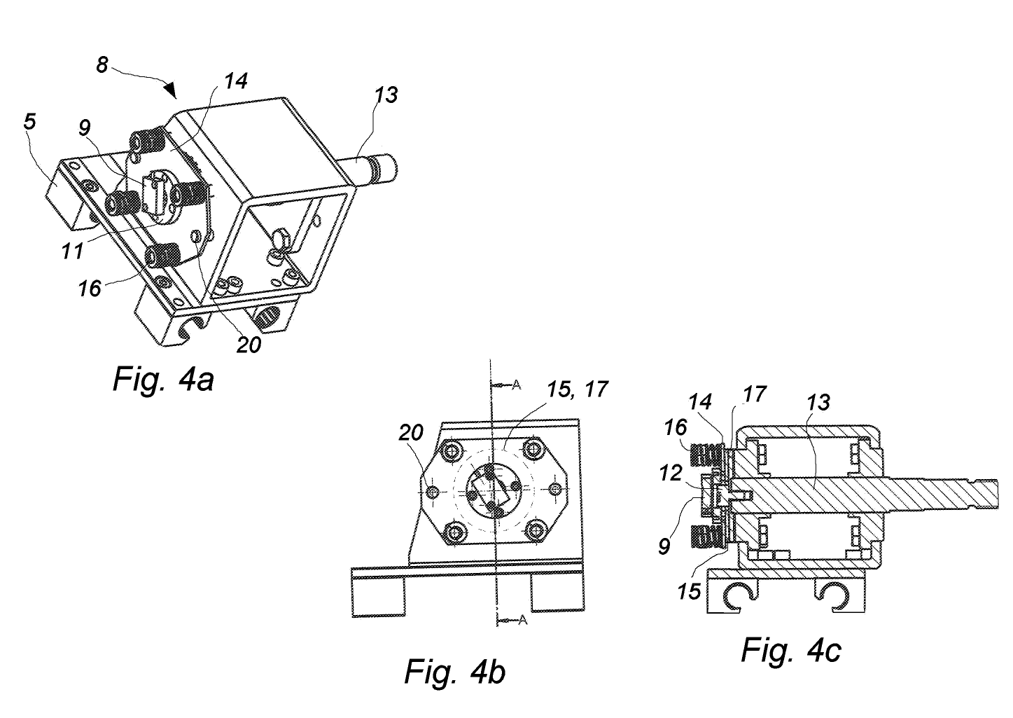

FIGS. 4a-4c show in greater detail the turning mechanism 8 of the sawing means 3 according to one embodiment. The figures show the axis 13 of the turning mechanism 8, onto which the sawing means 3 are connected. The figures further show the angle sensor 9 to measure the angle of rotation of the axis 13 and thus of the sawing means 3. The magnetic screw 12 of the angle sensor is connected to the end of the axis 13 and the sensor 9 itself is attached onto the disc 11.

The turning mechanism of FIGS. 4a-4c is provided with a pressure element, which presses the sawing means 3 towards the pile to be sawed. Preferably, this pressure element is a flexible pressure element in order that the sawing means is able to conform to the momentary great compressive forces, to which they are subjected in the direction deviating from the longitudinal direction of the gripping means 2, for example, when the saw blade strikes harder points in the concrete, such as stones. The flexible pressure element is preferably implemented as a torsion spring connected to the axis of the turning mechanism. The turning mechanism of the sawing means 3 is preferably further provided with a moving element, which performs the moving of the sawing means 3 and which is capable of moving the sawing means 3 against the force of the pressure element back into the start position. This moving element can be, for example, a hydraulic cylinder.

The disadvantage of the flexibility of the turning mechanism is that it can create a bouncing of the blade in the concrete, which decreases the efficiency of sawing and creates both uneven cutting result and wearing of the blade. This occurs, in particular, when using a spring having a too weak, i.e. a too low spring force in relation to the material to be cut.

The turning mechanism 8 of the sawing means 3 of a cutting device according to the invention is, for this reason, in addition to a conforming spring mechanism, also provided with an adjustable friction brake, which resists the flexible movement of the axis 13 and the therein connected sawing means 3. In the embodiment shown in FIGS. 4a-4c, the friction brake comprises a metal plate 17 attached to the end of the rotating rotational axis 13, to which metal plate is combined, for example, by gluing, a friction plate 15. The plates 17 and 15 are attached with a magnetic screw 12 to the end of the axis 13 turning along with it. The metal plate 17 is preferably also attached in a form-fitted manner to the end of the axis 13 using a non-circular opening in the metal plate and by making bevels in the end of the axis, which achieve form locking. On top of the friction plate 15 is fitted at least one compression plate 14, which is compressed by the adjustment springs 16 against the plate 15, thus braking by friction the movement of the plate 15 and the axis connected therein. By adjusting the adjustment screws 16 provided with springs, which can be, for example, two or four, it is possible to set the magnitude of the braking force of the friction brake and then how stiff or flexible the flexibility of the turning mechanism is. The adjustment screws 16 attach the plate 14 in a non-rotational manner to the frame of the turning mechanism 18. By means of the locking pegs 20, the plate 14 can be locked in place in relation to the frame of the turning mechanism without any gap, even if there were to be a slight clearance at the screw connections. The friction brake can also be implemented in a different manner than what is presented. The friction brake prevents the bouncing of the blade during sawing and, at the same time, allows a flexible feature, which can be adjusted as suitable, for example, according to the material to be cut.

The device further has a protective casing (not shown in the drawings), to the bottom of which, below the saw blade is arranged a discharge opening, in connection with which is arranged a part guiding away the sawing dust.

1. A device for cutting concrete piles, comprising a frame, gripping means connected to the frame and comprising at least two opposing gripping parts, which are movable at least closer to each other to form a closing grip around a pile and further away from each other to release a pile from the closing grip, and sawing means, which, when using the device, are to be taken on the two opposite sides of the pile to perform a back and forth sawing movement moving along a horizontal guide rail attached to the frame and which are further arranged to turn towards the pile to be sawed and back around their rotational axis wherein the device comprises a turning mechanism, an angle sensor arranged in the end of the rotational axis for measuring the angle of rotation of the sawing means and elements for defining the location of the sawing means on the guide rail and control elements for controlling the sawing means on the basis of the signals from the angle sensor and the elements defining the location of the sawing means to perform a de-sired sawing profile in the concrete pile to be cut.

2. The device according to claim 1, wherein the device comprises an inductive sensor for detecting the steel rebars in the pile.

3. The device according to claim 1, wherein the device comprises an adjustable friction brake arranged in the turning mechanism.

4. A computer program containing a computer program for controlling a device according to claim 1 to perform a desired sawing profile in the concrete pile to be cut.

5. The device according to claim 2, wherein the device comprises an adjustable friction brake arranged in the turning mechanism.

6. The computer program containing a computer program for controlling a device according to claim 2 to perform a desired sawing profile in the concrete pile to be cut.

7. The computer program containing a computer program for controlling a device according to claim 3 to perform a desired sawing profile in the concrete pile to be cut.
